(19) United States
(12) Patent Application Publication
(10) Pub. No.: US 2022/0040961 A1
(43) Pub. Date: Feb. 10, 2022

(54) Structural Materials

(71) Applicant: PAUA TRADING LIMITED, Chichester (GB)

(72) Inventors: Peter BLADD-SYMMS, Chichester (GB); Michael TITLEY, Chichester (GB)

(21) Appl. No.: 17/275,657

(22) PCT Filed: Sep. 13, 2019
(86) PCT No.: PCT/GB2019/052580

§ 371 Date: Mar. 11, 2021

(30) Foreign Application Priority Data
Sep. 13, 2018 (GB) 1814919.5
Jan. 11, 2019 (GB) 1900439.9
Sep. 5, 2019 (GB) 1912777.8

(51) Int. Cl. B32B 27/06; B32B 27/32; B32B 5/18; B32B 5/24

(52) U.S. Cl. CPC B32B 27/065; B32B 27/32; B32B 5/18; B32B 5/245; B32B 2419/00; B32B 2307/558; B32B 2250/02; B32B 2266/0214; B32B 2307/72

(57) ABSTRACT

There is described a structural sheet or protective panel, comprising a layer of self-reinforced polyolefin; a layer of polymer foam, wherein the layer of self-reinforced polyolefin and polymer foam are bonded together to form a laminated structure. The structural sheets (alone or in combination with other structural sheets) can be configured as protective structures. Protective panels, roof panels, window or door shutters, running boards and fencing panels are described.

### FIELD OF THE INVENTION

The present invention relates to structural materials and in particular, their use in window and door shutters, impact proof panels and window protection. These structural materials may be made from various types of self-reinforced polyolefins.

### BACKGROUND OF THE INVENTION

There are various uses for rigid structural panels. These include building materials, temporary structural reinforcements (e.g. storm protection), and robust packaging. Typically, such items are formed from metals (e.g. aluminium), and wood (e.g. plywood). However, such materials can have drawbacks. For example, for a particular strength, metal panels may be heavy. Although more lightweight, wood may not be robust (it may shatter or splitter when exposed to projectiles).

Therefore, there is required a material that overcomes these problems.

### SUMMARY OF THE INVENTION

Accordingly, there is described a structural panel or protective sheet that can be incorporated into various structures, including storm protection panels, roof tiles, and window or door shutters. The structural panels can also be configured as fencing panels or hoardings. The structural panels incorporate at least a layer or sheet of a self-reinforced polymer (or polyolefin) material. In a preferred embodiment, the structural panel comprises a laminated structure of at least a layer or sheet of a self-reinforced polymer (or polyolefin) material, and a layer or sheet of a polymer foam.

In a first aspect, there is described a structural sheet or protective panel, comprising:

a layer of self-reinforced polyolefin;

a layer of polymer foam;

the layer of self-reinforced polyolefin and polymer foam bonded together to form a laminated structure.

In a particularly advantageous example, the structural sheet or protective panel can be configured as a roof tile or window or door shutter, for protection of building from debris or missiles. For example, the structural sheet may be configured as a roof tile, roof panel, shutter or other protective panel in order to protect buildings and structures from extreme weather events (hurricanes, typhoons), or from military or conflict damage (as a result of missiles or explosions). In some cases battens of self-reinforced polyolefin may be attached to a planar surface of the structural sheet, to provide reinforcement and stiffening.

The layer of self-reinforced polyolefin (or self-reinforced polymer) may comprise a layer or planar sheet of a type of polymer produced from a simple olefin (also called an alkene with the general formula CₙH₂ₙ) as a monomer. Self-reinforced polyolefins (or polymers) are a particular family of thermoplastic composite materials in which both the reinforcing fibre and the polymer matrix are formed from the same polymer family. The fibres are manufactured as a highly oriented form of the same polymer matrix. Self-reinforced polymeric composite materials possess many advantages including thermoformability, high stiffness, high tensile strength, and outstanding impact resistance at low density. Self-reinforced materials are particularly impact resistant in comparison to their lightweight characteristics. Furthermore the material can be melted and recycled, thus fulfilling requirements for use of more sustainable materials.

Most preferably, the structural sheet comprises a layer of self-reinforced polyolefin, the layer comprising one of: self-reinforced polypropylene (srPP), self-reinforced polyethylene (SRPET).

Preferably, the layer of polymer foam comprises a polymer foam having a density of less than 150 grams per litre, or more preferably less than 100 grams per litre. The polymer foam may be a polyolefin foam. The foam may be close cell or open cell. The density of the polymer foam may be in the range of 20 to 180 grams per litre, but more preferably is in the range between 30 to 90 gms per litre. This density ensures the foam is sufficiently resilient (or adaptable) to absorb energy from an impact so as to protect an adjacent object.

Preferably, the layer of polymer foam is a layer comprising one of: expanded polypropylene (EPP), ethylene vinyl acetate (EVA), EVE, expanded polyethylene (EPE), expanded polystyrene (EPS), or Microcellular polypropylene (MEPP); polyethylene foam; Plastazote.

Preferably, the structural sheet further comprises one or more additional layers bonded within the laminated structure, the one or more additional layers each comprising at least one of: a second layer of self-reinforced polyolefin; a second layer of polymer foam; a layer of fabric; a vinyl layer; a fire retardant layer. The structural sheet may incorporate any number of additional laminated layers, in addition to the layer of self-reinforced polyolefin and the layer of polymer foam. For instance, the structural sheet may comprise a second layer of self-reinforced polyolefin, such that the resilient polymer foam is sandwiched between two layers of the self-reinforced polyolefin. This provides a robust protective layer for the energy absorbing polymer foam. In other examples, a vinyl layer (for instance printed with an advertisement, a safety warning, or other wording) could be applied as an outermost layer of the structural sheet. This can convey information when the structural sheet is in use.

In a particular example, a vinyl layer may be used as an uppermost layer (so that the self-reinforced polyolefin layer is between the vinyl layer and the polymer foam layer) when the structural sheet is configured as part of a window or door storm shutter. The printed vinyl layer may be used to display a warning that the shutter may obscure broken glass or other hazards. In another alternative, a fire-retardant layer may be incorporated into the laminated structure.

Optionally, at least one of the one or more additional layers are arranged such that the layer of polymer foam is arranged between the layer of self-reinforced polyolefin and the one or more additional layer. In other words, the layer of polymer foam is sandwiched between the layer of self-reinforced polyolefin and the one or more additional layer.

Optionally, at least one of the one or more additional layers are arranged such that the layer of self-reinforced polyolefin is arranged between the layer of polymer foam and the one or more additional layer. In other words, the layer of self-reinforced polyolefin is sandwiched between the layer of polymer foam and the one or more additional layer. Where two or more additional layers are used, they each may be arranged within the laminated structure in any position.

Preferably, the structural sheet is rigid or semi-rigid. In other words, the structural sheet is stiff, and may hold its shape. The sheet may be a rigid planar panel. Alternatively, the sheet may pliable and lack rigidity (as a tarpaulin or cloth-like structure).

Optionally, the structural sheet is corrugated. In other words, the laminated sheet or panel may be formed in a series of ridges and grooves. This may increase the strength and rigidity of the sheet.

Optionally, the structural sheet comprises one or more hinges, to permit folding of the structural sheet at the hinge. In other words, the structural sheet may be foldable at a specific hinge point. This may allow the structural sheet to be folded for more compact storage, or may allow the structural sheets to form more complex structures. In an example, a hinged structural sheet may form the walls of a temporary habitation (such as a tent). This, provision of one or more hinges allows the structural sheet to be used in temporary or moveable structures.

The structural sheet may be configured for a variety of purposes. In particular, the structural sheets (alone or in combination with other structural sheets) can be configured as protective structures. For example, the structural sheets can be configured for use as any of a protective panel, a temporary habitation structure, a roof panel, a window or door shutter, a fencing panel, a hoarding.

In a beneficial example, a protective panel may comprise the structural sheet.

In a further beneficial example, a building (or temporary habitation, such as a tent), a roof panel (or roofing tile) or a door or window shutter may comprise the structural sheet.

In a still further beneficial example, a fencing panel or protective hoarding may comprise the structural sheet.

The thicknesses of the layers in the structural sheet may be different depending on the application or purpose for which the structural panel is used. For instance, the structural panel configured as a roof tile may comprise a self-reinforced polyolefin layer having a thickness of between 0.5 and 10 mm, and/or a polymer foam layer having a thickness of between 1 to 20 mm.

The structural panel configured as a fencing panel or ballistic panel may comprise a self-reinforced polyolefin layer having a thickness of between 5 to 50 mm, and/or a polymer foam layer having a thickness of between 10 to 50 mm. In the fencing panel or ballistic panel, many alternating layers of the self-reinforced polyolefin material and the polymer foam may be used, and fused together in a single panel. This may improve sock absorbency.

The structural panel configured as a running board or protective panels (e.g. for walls and doors) may comprise a self-reinforced polyolefin layer having a thickness of between 0.8 to 10 mm, and/or a polymer foam layer having a thickness of between 3 to 15 mm.

The structural panel configured as a slat for a window or door shutter may comprise a self-reinforced polyolefin layer having a thickness of between 3 to 15 mm, and/or a polymer foam layer having a thickness of between 3 to 15 mm.

In a second aspect there is described a method of manufacture of a structural sheet, comprising:

providing a sheet of self-reinforced polyolefin;

providing a sheet of polymer foam;

bonding the sheet of self-reinforced polyolefin and the sheet of polymer foam together to form a laminated structure.

In particular, there is a method of manufacture of the structural sheet having the various characteristics described above. The sheet or layer of self-reinforced polyolefin, and the sheet or layer of polymer foam may also have any of the characteristics described above.

Preferably, the sheet of self-reinforced polyolefin is a sheet comprising one of: self-reinforced polypropylene (srPP), self-reinforced polyethylene (SRPET).

Preferably, the sheet of polymer foam comprises a polymer foam having a density of less than 150 grams per litre, or more preferably less than 100 grams per litre. The polymer foam may be a polyolefin foam. The foam may be close cell or open cell. More preferably, a closed cell foam is used, forming discrete pockets (or bubbles) enclosed within the material structure. The density of the polymer foam may be in the range of 20 to 180 grams per litre, but more preferably is in the range between 30 to 90 gms per litre.

Preferably, the sheet of polymer foam is a sheet comprising one of: expanded polypropylene (EPP), ethylene vinyl acetate (EVA), EVE, expanded polyethylene (EPE), expanded polystyrene (EPS), or microcellular polypropylene (MEPP) polyethylene foam; Plastazote.

Preferably, the method further comprises: providing one or more additional layers each layer comprising a sheet of at least one of: a second sheet of self-reinforced polyolefin; a second sheet of polymer foam; a sheet of fabric; a vinyl sheet and a fire retardant layer. The method may further comprise bonding the one or more additional layers within the laminated structure. The structural sheet may incorporate any number of additional laminated layers, in addition to the layer of self-reinforced polyolefin and the layer of polymer foam. The order or arrangement of the sheet of polymer foam, the sheet of self-reinforced polyolefin and the one or more additional layers may be in any combination within the laminated structure.

Preferably, providing one or more additional layers further comprises arranging the sheet of polymer foam between the one or more additional layers and the sheet of self-reinforced polyolefin.

Preferably, providing one or more additional layers further comprises arranging the sheet of self-reinforced polyolefin between the one or more additional layers and the sheet of polymer foam.

Preferably, the step of bonding comprises applying heat to the sheet of self-reinforced polyolefin, the sheet of polymer foam and any one or more additional layers. In a particular example, the method of bonding the sheet of self-reinforced polyolefin and the sheet of polymer foam (and any other layers) is by application of heat and/or pressure. For instance, a hot rod or iron may be placed on an upper surface of the laminated layers, in order to partially melt or bond the layers underneath.

Preferably, the temperature of the applied heat is between 120 and 140 degrees Celsius.

Preferably, the step of bonding further comprises applying pressure to the sheet of self-reinforced polyolefin, the sheet of polymer foam and any one or more additional layers.

Preferably, the applied pressure is 0.5 to 1 bar.

Optionally, the step of applying pressure is performed simultaneously with the step of applying heat.

Optionally, the step of bonding further comprises plasma bonding the sheet of self-reinforced polyolefin, the sheet of polymer foam and any one or more additional layers. This may cause heating of a portion or region of the laminated layers. The plasma bonding may cause localising melting of the layers, in order to form bonds therebetween.

Optionally, the step of bonding further comprises gluing, stitching, riveting or stapling the sheet of self-reinforced polyolefin, the sheet of polymer foam and any one or more additional layers. In other words, a fastener can be arranged to extend through the sheets of the laminate structure, and hold said layers together.

Optionally, the step of bonding is applied in a localised area of the sheet of self-reinforced polyolefin, the sheet of polymer foam and any one or more additional layers. For instance, the bonding may take place as bonding or anchor points arranged across the structural sheet. Optionally, the step of bonding is applied at the perimeter of the sheet of self-reinforced polyolefin, the sheet of polymer foam and any one or more additional layers. Bonding at only localised areas of the structural sheet (i.e. at less than 50% the surface area of the structural sheet, or less than 25% the surface area) maybe preferable. In particular, bonding via heat and pressure may disrupt the reinforcing fibres within the self-reinforced material, and so the impact resistance properties of the self-reinforced material may be changed at the bonding points.

In a third aspect there is a running board comprising a self-reinforced polyolefin material. The running board may be formed of a single self-reinforced polyolefin, or a combination of more than one type of self-reinforced polyolefin or a self-reinforced polyolefin with other materials. The running board may have the laminated structure of the structural sheet described above. The running board may have various fasteners to connect or mount the running board to a wall, door or other item. The running board may comprise an additional layer, arranged on top of a layer of self-reinforced polyolefin, that is printed. For instance this may display signs, messages or warnings.

The running board may be particularly useful to be applied to wall or doors in hospitals, warehouse or industrial settings. The running board will protect the wall from knocks or scuffs due to equipment being pushed or knocked into the wall (for instance, hospital beds, wheelchairs, forklifts etc).

In a fourth aspect there is a fencing panel (or ballistic panel) comprising a self-reinforced polyolefin material. The fencing panel may be formed of a single self-reinforced polyolefin, or a combination of more than one type of self-reinforced polyolefin or a self-reinforced polyolefin with other materials. The fencing panel may have the laminated structure of the structural sheet described above. The fencing panel may have holders, stands or feet to cause the panels to stand upright. The fencing panel may be stiff, or rigid, in order to hold its shape. The running board may comprise an additional layer, arranged on top of a layer of self-reinforced polyolefin, which is printed. For instance this may display signs, messages or warnings. Where the fencing panel incorporates a polymer layer, according t the structural panels described above, the foam may be of greater density (for instance, 100-250 gms per litre, and most preferably 180 gm litre). This helps improve the structural rigidity of the fencing panel, whilst keeping the panels lightweight.

The fencing panels may be particularly useful as temporary protection panels (ballistic protection panels). For this purpose they can be used in conflict zones or riot scenarios, to provide protection from missiles or projectiles to civilians or security/military personnel.

In a fifth aspect there is a roof tile comprising a self-reinforced polyolefin material. The roof tile may be formed of a single self-reinforced polyolefin, or a combination of more than one type of self-reinforced polyolefin or a self-reinforced polyolefin with other materials. The roof tile may have the laminated structure of the structural sheet described above. The roof tile may comprise various fixtures or mountings to connect to a roof structure. The roof tiles may comprise a fire retardant layer, in addition to the self-reinforced polyolefin material.

The roof tiles may be particularly robust and lightweight, with a long lifespan.

In a sixth aspect there is a window or door shutter comprising a self-reinforced polyolefin material. The window shutter may be formed of a single self-reinforced polyolefin, or a combination of more than one type of self-reinforced polyolefin or a self-reinforced polyolefin with other materials.

In a seventh aspect there is a window or door shutter, formed from one or more panel each comprising self-reinforced polyolefin. Each panel may be formed of a single self-reinforced polyolefin, or a combination of more than one type of self-reinforced polyolefin or a self-reinforced polyolefin with other materials.

Preferably each one or more panel comprises a layer of the self-reinforced polyolefin, a layer of polymer foam wherein the layer of self-reinforced polyolefin and polymer foam bonded together to form a laminated structure. A single panel may be arranged in a frame so as to fill the area within the frame. Once the window or door shutter is mounted to a respective window or door, this would completely block light from reaching said window or door.

Alternatively, a plurality of panels may be configured as a slats in a slatted window or door shutter, each slat secured within a frame. The slats may be arranged within the frame so that the plane of the slat is parallel (or perpendicular) to a plane defined by the frame. The slats may be spaced apart to allow light between. In another example, a plurality of slats may be arranged within the frame as plantation shutters. In this example, each slat may be arranged so that the plane of the slat is at an angle to the plane defined by the frame.

Preferably, the one or more panel is arranged within a frame. The frame may be formed from struts, each strut comprising self-reinforced polyolefin. Alternatively, the frame could be comprised of wood or other material.

Preferably, each strut comprises a layer of the self-reinforced polyolefin, and a layer of polymer foam, wherein the layer of self-reinforced polyolefin and polymer foam bonded together to form a laminated structure.

Optionally the frame further comprises fasteners and/or hinges for connection to a building. The frame of the window or door shutter may comprise hinges for attachment to a door frame, window frame or other portion of the building, in either an open or closed position. The frame of the window or door shutter may also comprise a fastener or catch for holding the shutter in an open or closed position.

Preferably, each panel is configured as a slat in a slatted window or door shutter, each slat secured within the frame. Preferably, the slats are fixedly arranged in the frame so as to allow light to pass through the shutter between the slats. Alternatively, the slats are moveably arranged in the frame so as to allow light to pass through the shutter between the slats when the slats are moved to a first position and so as to block light passing through the shutter when the slats are moved to a second position. For example, the slats may move from a configuration in which each slat is parallel or nearly parallel to the plane defined by the frame, to a configuration in which each slat is perpendicular or nearly perpendicular to the plane defined by the frame. In this way, the slats can be moved from a position which allows light therebetween, and position when light through the shutter is substantially blocked.

Beneficially, the window or door structure formed using panels having the described laminated structure may have a typical shutter appearance, and be aesthetically pleasing. However, they offer more lightweight and robust protection for windows and doors when secured in place than compared to similar shutter designs in wood or metal. As such, the described window or door shutters may be particularly useful in geographical regions where severe weather is common (including hurricanes or typhoons, for instance). The shutters may be permanently, hingedly fixed to the window or door frame so that they can be opened or closed according to need.

In particular examples, srPP (self-reinforced polypropylene) or srPET (self-reinforced polyethylene) can be utilised to make impact proof panels for use in building protection such as hurricane protection or flying debris protection such as European seaside window protection. In addition, it can be deployed in certain areas of buildings, such as stable doors or horse boxes or transportation to protect from other impacts such as horse's hooves, or in barns where animals can cause damage to wooden structures. The srPP or srPET can be used alone or in combination with expanded polypropylene (EPP) or similar foam, such as microcellular polypropylene or other polyolefin foam substrate whereby the addition of EPP or the replacement foam softens the transmission of force through the combined material thereby absorbing the impact force and protecting the item below.

A manufacturing method for adhering self-reinforced polyolefins such as SRPP or SRPET to microcellular foams is as follows:

Microcellular polypropylene (MEPP) or similar foam is adhered to spPP or srPET (e.g. in sheet form) by heat and pressure bonding self-reinforced plastic (srPP and srPET) to the MEPP foam by stacking in a heat press at temperatures and pressures preferably by not limited to between 120-140 degrees C. and 0.5 to 1 bar of pressure alternatively the foam and srPP/srPET can be plasma bonded or glued together. Other example temperature ranges include 100-160 degrees C. and other example pressures include 0.2 to 1.5 bar or higher. The MEPP may be bonded according to the above example technique as a substrate between sheets of srPP or srPET.

Such an example of a product that incorporates any of these materials may include a very lightweight window covering for storm protection over windows near shingle beaches, or temporary spectator protection at events where there is flying debris such as rally events.

Furthermore the invention allows such panels of srPP/srPET sandwich between a foam substrate (e.g. MEPP) to be stitched, riveted, stapled or glued to manufacture the panels.

The combination of an SrPP/SrPET layer over EPP or microcellular foams (e.g. MEPP) or similar substrates and then another srPP/srPET layer can at certain configuration absorb significant impact from example shotgun pellets or shrapnel and can provide such protection that can quickly be erected or manufactured into items due to its very lightweight properties. The srPP and/or srPET can also be laid up in layers of approximately 50 to 300 layers in order to provide movable ballistic resistant panels that can still be assembled and moved by a relatively small team of personnel.

An example of such would be the construction of military field fencing or kit buildings that can be erected quickly at a military camp offering protection from shrapnel, a low radar footprint due to the plastic materials used provides an additional synergistic benefit, and also having EPP or microcellular foam (e.g. MEPP) gives insulation benefits to humans in the case of field buildings in military or emergency use such as aid hospitals. Again, this provides an additional synergistic effect. The panels can be easily pre-cut to patterns and assembled using a means of coupling (e.g. interference fittings, glue, mechanical fixings, etc.). They will be resistant to rot and rust due to the polypropylene construction and be end of life recyclable.

Hurricane Protection

srPP and/or srPET (especially but not limited to those materials in the above-mentioned sandwiched forms) can be manufactured in large sheets, similar to plywood, and can be stored and cut issued to customers as requested who can then cut to size or fit as appropriate.

srPP has several advantages over plywood—the most common emergency protection material—srPP and srPET (especially but not limited to the above-mentioned sandwiched forms) are more impact resistant, they are completely weather proof, will last much longer but can still be cut and screwed and drilled similar to wood with common tools, which is critical for less developed areas probe to hurricanes and typhoons.

Planks of these composite materials (either as a single layer or as a composite having outer layers of srPP or srPET with EPP or MEPP between them) may be post processed or manufactured into shutters, such as roller shutters, plantation shutters, Bahama/Caribbean shutters or similar—so thereby replacing wood and offering considerably more protection—so there would be no need to put on additional protection over the window. In some embodiments there would then only be the requirement to close the srPP or srPET shutters in order to afford the required protection. srPP and srPET (e.g. but not limited to the above-mentioned sandwiched forms) have advantages over common hurricane proofing shutter material such as aluminium and wood in that they are also inert to coastal conditions (e.g. seawater, wind, spray, etc.).

In addition srPP/srPET, or srPP/srPET and EPP/MEPP sandwich construction (or similar foam substrate, such as other microcellular foams) can be formed into long strips and joined by sewing or riveting with further thin strips of srPP/srPET or webbing to form roller shutters, panels, cases or similar Lightweight ad-hoc storm protection.

Generic Impact Panels;

Hospitals typically use stainless steel panels around doors so that when beds are pushed around the hospital they don't damage doors, similarly warehouses use a lot of aluminium protective edging to protect from forklifts, this can be replaced with srPP/srPET—which is chemically inert and would offer advantages such as being quieter when hit by a trolley—quietness is important in a hospital. In another embodiment the srPP/srPET can be combined with EPP or MEPP (or other similar foam or microcellular foam) for a softer impact resistance and may be even quieter.

Commercial Vehicle Panelling;

Most commercial vehicles are panelled with plywood to offer impact resistance when being unloaded/loaded. spPP/srPET (and any of the above-mentioned sandwiched materials) offer longevity and better impact, cut and penetration resistance than traditional plywood. These materials also have less friction than wood and thus items can be slid into vans easier.

In addition by adding a pre-printed plastic sheet into the pressing with the srPP or srPET consolidation process then you can make specific applications that then do not require further covers of material to be stitched over the top of the srPP/srPET reducing manufacturing costs and time.

Such an example would be a pre-printed camouflage pattern in non-woven or woven polypropylene that is added as the final layer in the consolidation of multi-layer srPP/srPET—this would then mean that military items can be manufactured straight from the srPP/srPET (or the above-mentioned sandwiched composite materials) without the need for additional cost and materials.

The following numbered clauses describe further example implementations. In particular, this includes the use of srPP or srPET to:

1. Make temporary storm/hurricane shuttering for houses, windows, doors, and commercial buildings.

2. Make shutters such as Caribbean shutters, accordion, colonial or plantation shutters instead of wood in order to provide permanent hurricane proofing but with aesthetic effect.

3. Be fashioned to make roller shutters replacing wood or metal which corrode in typical coastal storm prone areas.

4. As above but with EPP, EVA, EPE, microcellular foams made from polyolefin compounds or EPS as a backing foam to provide impact softening.

5. The use of spPP/spPET panel for impact protection such as: stable doors, other equine transportation; hospital doors, warehouses where the beds are pushed into doors to open, machinery impact, garaging for car protection; and commercial vehicle paneling for the inside of builders or delivery vans.

6. The use of spPP/spPET and epp EVA, EPE, microcellular foams made from polyolefin compounds or eps or similar foam substrate in all of the above to further dampen impact.

7. Manufacturing method for adhering self-reinforced polyolefins such as SRPP or SRPET to microcellular foams by heat and pressure bonding self-reinforced plastic such as SRPP and SRPET to the microcellular foam by stacking in a heat and pressure press at temperatures between 120-140 degrees C. and 0.5 to 1 bar of pressure

8. The use of such panels in animal delivery or general husbandry to protect the animal from self-harm or damage in transit.

9. The use of a single sided srPP or srPET panel in conjunction with a foam substrate such as microcellular foams (e.g. MEPP) in impact proof applications such as personal protective body armour or bomb resistant suits.

10. The use of a double or single sided sandwich srpp or srpet panel in conjunction with a foam substrate such as microcellular foams in impact proof applications such as personal protective body armour or bomb resistant suits.

11. Sew rivet or stitch into stab such sandwich panels made from impact proof srPP/srPET and microcellular foam or similar into body protection for humans and animals.

12. The addition of preprinted plastic fabrics as the top layer in srPP or srPET consolidation processing to make items that are immediately ready for uses whereby normally an additional fabric would be required such as military camouflage.

13. In respect of the above where the preprinted fabric is in itself fire retardant or has an additional film put underneath.

14. Construction of fencing or barriers made from srPP or srPET to protect persons from shrapnel, bomb blasts, bullets or flying debris, such panels to be movable for temporary erection at events or similar, or for more permanent erection at facilities where security, storm or debris damage is likely.

15. The covering of such panels in printed vinyl or similar printed matter sheets for the purpose of camouflage, signage or advertising media.

16. The use of srPP/srPET to construct large panels or sheets as an underlay to roof tiles to give additional protection on roofing of houses or commercial properties to protect from storm damage such as hailstones or debris.

17. The use of srPP/srPET to construct small tiles or roof shingles whereby the tiles or shingles are more impact resistant that standard house tiles.

18. The use of srPP or srPET pressed by thermoforming into corrugated sheets for use in roofing or for use as shuttering and in general construction.

19. The use of srPP/srPET in the above clauses 16, 17 and 18 together with a foam substrate such as EPP, ethylene vinyl acetate (EVA), EVE, expanded polyethylene (EPE), expanded polystyrene (EPS), or Microcellular polypropylene (MEPP) applied to the srPP/srPET top layer by gluing, riveting, heat, pressure or stitching (to produce a laminated product), preferably, the laminated or layered product to further dampen impact and improve resilience.

20. The addition of a bottom or additional layer of srPP or srPET to the above to create a sandwich (for instance, of EPP, EVA, EVE, EPS etc., between layers of either srPP or srPET).

21. A method for manufacturing sheet material, the method comprising the steps of: bonding a sheet of microcellular polypropylene, MEPP, between two sheets of self-reinforced polypropylene, srPP, or self-reinforced polyethylene, srPET.

22. The method of clause 21 further comprising the step of applying heat to bond the MEPP and sheets of srPP or srPET.

23. The method of clause 22, wherein the heat is between 120 and 140 degrees Celcius.

24. The method according to any previous clause, wherein the two sheets of srPP or srPET are outer sheets of the sheet material.

25. The method according to any previous clause further comprising the step of applying pressure to bond the MEPP and sheets of srPP or srPET.

26. The method of clause 25, wherein the pressure is 0.5 to 1 bar.

27. The method according to any previous clause further comprising plasma bonding or gluing the MEPP and sheets of srPP or srPET.

28. A structural sheet comprising sheet of microcellular polypropylene, MEPP, between two outer sheets of self-reinforced polypropylene, srPP, or self-reinforced polyethylene, srPET.

29. The structural sheet of clause 28, wherein the MEPP is bonded to the outer sheets using: heat and/or pressure; glue; stitches; rivets; staples; and/or plasma bonding.

30. A protective panel comprising the structural sheet according to clause 28 or 29.

31. A building comprising the structural sheet according to clause 28 or 29.

32. A roof panel comprising the structural sheet according to clause 28 or 29.

33. A shutter comprising the structural sheet according to clause 28 or 29.

It should be noted that any feature described above may be used with any particular aspect or embodiment of the invention.

### LIST OF FIGURES SHOWING SPECIFIC EMBODIMENTS

The present invention will now be described, by way of example only, with reference to the accompanying drawings, in which:

FIG. 1 shows a structural sheet;

FIG. 2 shows a further example of a structural sheet;

FIG. 3 shows a still further example of a structural sheet with localised bonding;

FIG. 4 shows a further example of a structural sheet with perimeter bonding;

FIG. 5 shows a window frame and window louvres configured from structural panels comprising the described laminated structure;

FIG. 6 shows a roller shutter configured from structural panels comprising the described laminated structure;

FIG. 7 shows a possible structure for a protective shutter or blind formed from structural panels;

FIG. 8 shows field fencing or protective barriers formed using the described structural panels;

FIG. 9 shows the use of the described structural panels fitted to the roof of a building;

FIG. 10 shows the use of structural panels applied to a roof or outer surface of a building for protection (such as hurricane or storm protection);

FIG. 11 shows the use of structural panels on a roof of a building;

FIG. 12A shows roof tile configured from a structural panel;

FIG. 12B shows an alternative roof tile; and

FIG. 13 shows corrugated roofing sheets configured from the structural panel.

In the drawings, like parts are denoted by like reference numerals. The drawings are not drawn to scale.

### DETAILED DESCRIPTION OF THE PREFERRED EMBODIMENTS

Structural Panel

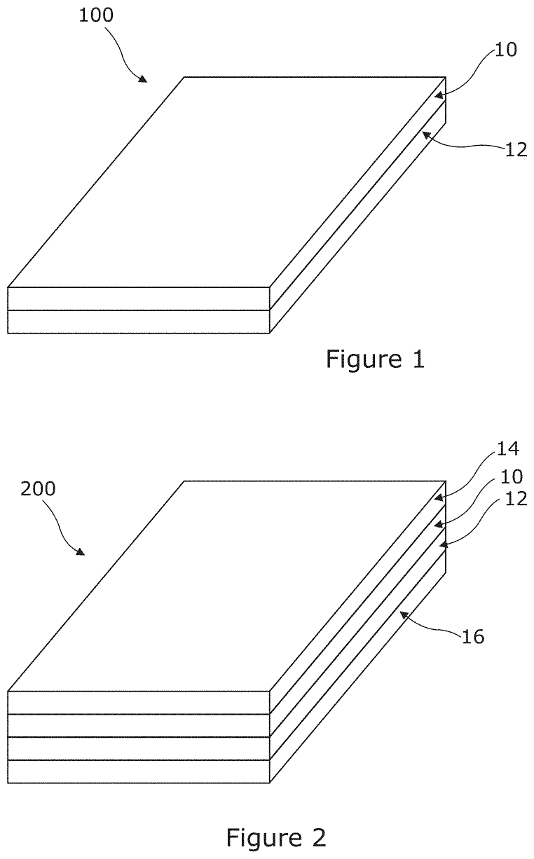

A perspective view of a structural panel is shown in FIG. 1. The structural panel can be configured for use in various applications, as outlined below.

The structural panel of FIG. 1 comprises a laminated structure of two planar layers. A first layer 10 comprises a sheet of a self-reinforced polyolefin material. In FIG. 1, this material is self-reinforced polypropylene (srPP), but other self-reinforced polyolefins (such as self-reinforced polyethylene) could be used.

The first layer 10 is arranged on top of or adjacent a second layer 12 comprising a polymer foam. In this case the polymer foam is expanded polypropylene with a density of between 30 to 90 grams per litre.

The first 10 and second 12 layer are bonded or secured together, to form a panel 100. The panel is semi-rigid. Advantageously, the self-reinforced polyolefin layer is robust and offers significant protection from impacts. Furthermore, the polymer foam layer is resilient and can absorb the energy of such impacts. Together, the structural panel provides a hard wearing and lightweight impact protection panel or sheet, which can be formed into various applications.

FIG. 2 shows a perspective view of a further embodiment of the structural panel 200. The panel of FIG. 2 comprises the self-reinforced polyolefin layer 10 and the polymer foam layer 12 described above with respect to FIG. 1. However, the structural panel of FIG. 2 further comprises a vinyl layer 14, on top of and bonded to the self-reinforced polyolefin layer 10. In other words, the self-reinforced polyolefin layer 10 is sandwiched between the vinyl layer 14 and the polymer foam layer 12.

The vinyl layer 14 is impregnated with ink. The vinyl layer may include printed text, colours or images. For instance, warning signs or text may be printed on the vinyl layer. The vinyl layer may provide a waterproofing layer.

The structural panel 200 of FIG. 2 also includes a fire retardant layer 16 bonded to the polymer foam layer 12. In other words, the polymer foam layer 12 is sandwiched between the fire retardant layer 16 and the self-reinforced polyolefin layer 10.

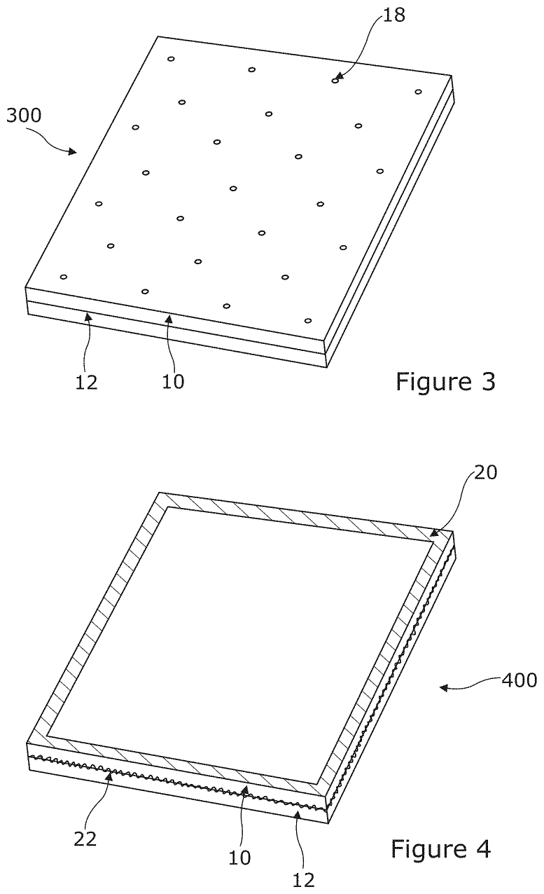

FIG. 3 shows a perspective view of the structural panel 300, having the laminated structure of the panel in FIG. 1. Here, the first 10 and second 12 layers of the panel have been bonded by application of heat to localised areas 18 at the structural panel. The heat may be applied to localised areas 18 by application of a hot iron or rod to portions of the surface of the structural panel 300. This can melt the localised portions 18 of the self-reinforced polyolefin layer 10 and the polymer foam layer 12 to bond the two layers in the localised regions 18. Bonding the layers only in localised areas is sufficient to securely fasten the layers of the laminated material together, but without disrupting the fibres of the self-reinforced material.

Although the localised areas 18 are shown as distributed across the surface of the structural sheet 300 in FIG. 3, it will be understood that any number of bonded regions may be provided, with any distribution, spacing or patterning across the planar area of the panel.

FIG. 4 shows an alternative embodiment, in which the first 10 and second 12 layers of the laminated structure are bonded at the perimeter of the structural panel 400. Again, the bonding is achieved by heating a strip or border 20 at the edge or perimeter of the panel, in order to melt only these portions of the laminated layers in order to be fused together (as shown by fused region 22).

Impact Proof Panels, Door and Window Shutters and Window Protection Made from Self-Reinforced Polyolefins.

Self-reinforced polyolefin panels (comprising, for example, srPP (self-reinforced polypropylene) or srPET (self-reinforced polyethylene)) can be utilised to make impact proof panels for use in building protection such as hurricane protection or flying debris protection such as European seaside window protection. In addition, it can be deployed in certain areas of buildings, such as stable doors to protect from other impacts such as horse's hooves, or in barns where animals can cause damage to wooden structures.

The srPP or srPET can be used alone or in combination with EPP (expanded polypropylene) or similar foam substrate whereby the addition of EPP softens the transmission of force through the combined material thereby absorbing the impact force and protecting the item below. Such an example might include a very lightweight window covering for storm protection over windows near shingle beaches, or temporary spectator protection at events where there is flying debris such as rally events.

The combination of a srPP/srPET layer over EPP and then another srPP/srPET layer can at certain configuration absorb significant impact from example shotgun pellets or shrapnel and can provide such protection that can quickly be erected due to its very lightweight properties.

An example of such would be the construction of military field fencing or kit buildings that can be erected quickly at a military camp offering protection from shrapnel, a low radar footprint due to the plastic materials used, and also having EPP gives insulation benefits to humans in the case of field buildings in military or emergency use such as aid hospitals. The panels can be easily pre-cut to patterns and assembled using a means of coupling. They will be resistant to rot and rust due to the polypropylene construction and end of life recyclable.

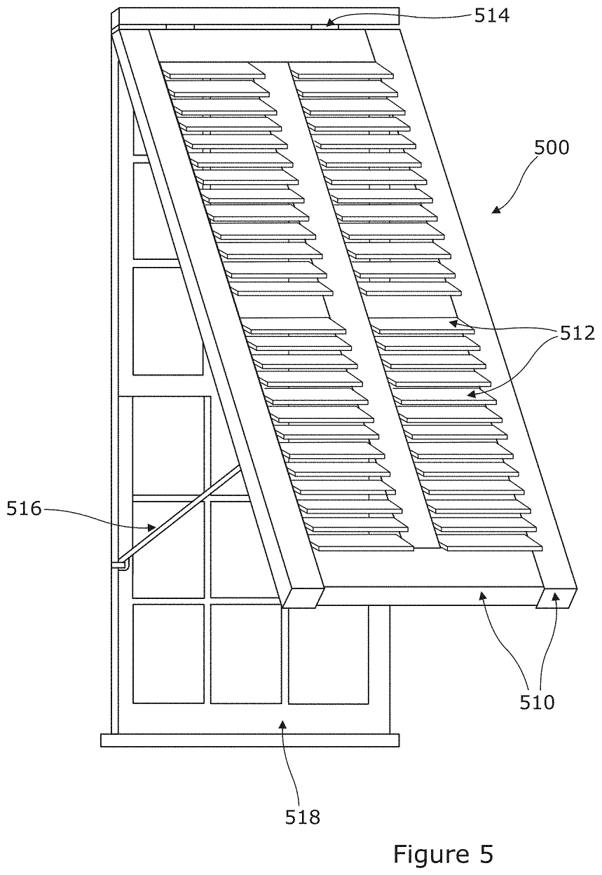

FIG. 5 shows a srPP/srPET sheet manufactured to make a window frame and window louvres (window shutter), instead of wood. This is beneficial to ‘weather proof’ a building, for instance.

The window shutter 500 of FIG. 5 includes a frame formed of struts 510 each configured from a structural panel as discussed above. The window shutter further comprises slats 512, each formed from a structural panel as discussed above. The slats 512 are arranged in the frame to provide a protective barrier to be placed in front of a window 518. In this case, the slats 512 are arranged spaced apart in the frame such that the plane of each slat is at an approximately 45° angle to the plane of the shutter frame. This allows some light to pass through the shutter, even when the shutter is arranged over the window. However, this arrangement of the slats also provides protection to the window from impacting missiles, projectiles or flying debris.

The shutter 500 of FIG. 5 further comprises a hinge 514 to hingedly connect the frame of the shutter to a window frame or building. In this way, the shutter may be fixed to a building, and arranged in an opened or closed position. The shutter 500 of FIG. 5 further includes a fastener 516, for holding or maintaining the shutter in an open or closed position.

In an alternative example, each of the slats and struts described with respect to the window shutter in FIG. 5 could be provided without use of polymer foam. In other words, the slats and struts may be formed of a self-reinforced polyolefin material only, or in combination with other materials.

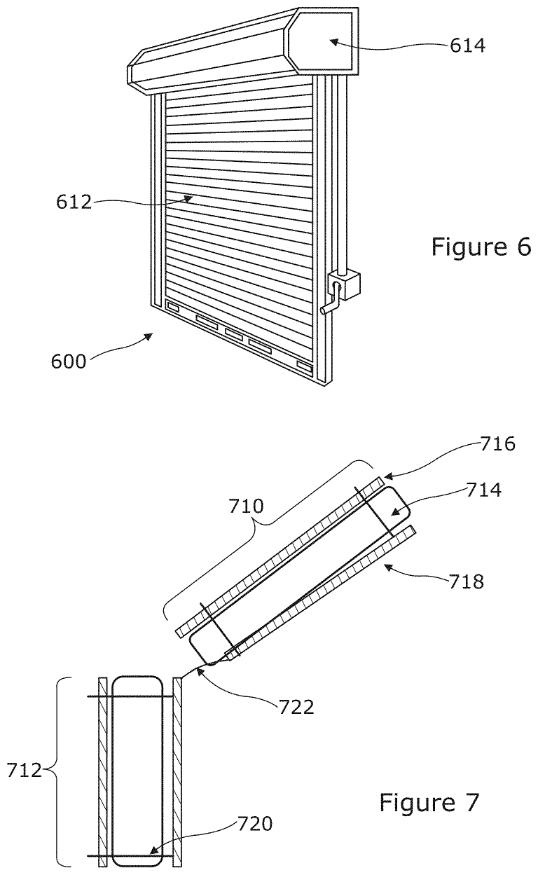

FIG. 6 shows a srPP or srPET roller shutter 600. Thus, FIG. 6 shows an example of a roller shutter comprising self-reinforced polyolefin material. The roller shutter may comprise slats 612, each hingedly fixed to each other as described below with respect to FIG. 7. Each slat 612 may be formed of a structural panel or sheet as described above. The shutter may include a manual or automated roller mechanism 614. Again, this shutter can be used for protection and/or weather proofing of a building.

In an alternative example, each of the slats described with respect to the shutter in FIG. 6 could be provided without use of polymer foam. In other words, the slats may be formed of a self-reinforced polyolefin material only, or in combination with other materials.

FIG. 7 shows a possible structure for a protective shutter or blind. In particular, the structure shown in FIG. 7 may be use to provide the roller style shutter of FIG. 6.

As shown in FIG. 7, a plurality of slats or battens 710, 712 each formed from the structural sheet described above may be hingedly connected to form a shutter layer, sheet or panel. In particular, each slat 710, 712 is formed from a layer of polymer foam 714 (here, expanded polypropylene or similar) sandwiched between two layers of self-reinforced polyolefin 716, 718 (here, self-reinforced polypropylene). Within each slat, the layers are bonded by provision of a fastener 720 (such as a stich, rivet or glue). However, application of heat and pressure could instead be used to bond the layers of the slat 710, 712.

The plurality of slats 710, 712 may be connected by a hinged joint 722. The hinged joint 722 may be provided by use of webbing fabric or self-reinforced polyolefin material to join the slats 710, 712. As such, the slats can be folded or concertinaed with respect to each other. This allows the shutter panel (comprising a plurality of slats) to be rolled or folded for storage.

In an alternative example, each of the slats described with respect to the shutter in FIG. 7 could be provided without use of polymer foam. In other words, the slats may be formed of a self-reinforced polyolefin material only, or in combination with other materials.

Fencings, Barriers or Hoardings Made from Self-Reinforced Polyolefins

Protective barriers formed of srPP, or a combination of srPP with srPET or EPP could also be formed. These applications may make use of layers of srPP that are 3 mm thick or more. The barriers could be flexible, and arranged upon a mounting frame, or could incorporate a thickness of srPP such that the barriers are rigid or semi-rigid.

Similarly, advertising hoardings or panels could be formed from srPP. Said hoardings may comprise a sheet of srPP alone, or in combination with other materials such as EPP or srPET. An image may be printed on the srPP layer, or otherwise incorporated into the hoarding (including a printed layer, laminated with the srPP layer any further layer (such as srPET or EPP).

Advantageously, said protective barriers or advertising hoardings are robust and can withstand heard wear from weather etc. Furthermore, the barriers and hoarding scan provide protection (for instance, from shrapnel or bullets) to persons behind or enclosed by said barrier or hoardings.

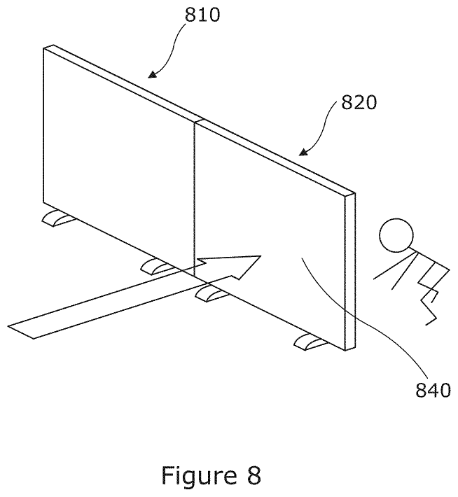

FIG. 8 shows field fencing or protective barriers 810, 820 formed of structural panels. The field fencing or protective barrier panels 810, 820 formed may be formed using a layered structure including a self-reinforced polyolefin (e.g. srPP, srPET or a combination of the two materials). The fencing or protective barrier panels 810, 820 formed may be formed according to the structural panels described above. The fencing or protective barrier panels 810, 820 may further comprise a stand or foot, to allow the panels to be arranged in an upright position.

The barriers can provide protection from shrapnel, bullets, or missiles or as protection from other impacts from blast or flying debris etc. A printed layer (for example, a printed vinyl layer or similar) may be applied to an outer side 840 of the described protective barrier to provide camouflage, advertising hoardings or information boards. Said hoarding and barriers are robust and weatherproof. Said hoardings could be used as robust and secure fencing, or for military protective purposes.

Each structural panel (configured as a fencing panel or hoarding 810, 820) may comprise one or more hinges. In this way, an otherwise flat panel can be bent or folded at the hinge. Thus, the hoardings or fending can be bent to fit around a required area or object, or can be folded for storage.

In an alternative example, each of the panels described with respect to the fencing or barriers in FIG. 8 could be provided without use of polymer foam. In other words, the panels may be formed of a self-reinforced polyolefin material only, or in combination with other materials.

Roofing Panels or Roof Tiles

Panels of srPP or srPET (or a combination) can be used, for instance together with traditional roofing materials and techniques, to reinforce rooves in geographical areas prone to hurricanes, typhoons and other extreme weather (including hail storms, heavy snow etc.). For instance, a srPP or srPET layer (in some examples, in combination with other materials such as EPP, srPET etc.) can be arranged underneath or over the top of traditional roof tiles, roof felt etc. The srPP or srPET panels can be permanently fixed within the traditional roofing structure, to provide long term protection.

In a still further embodiment, a plurality of srPP panels (in some examples, in combination with other materials such as EPP, srPET etc.) can be arranged for use as roof tiles. For instance, said srPP tiles can be arranged to be covering a roof in the manner of traditional roof tiles.

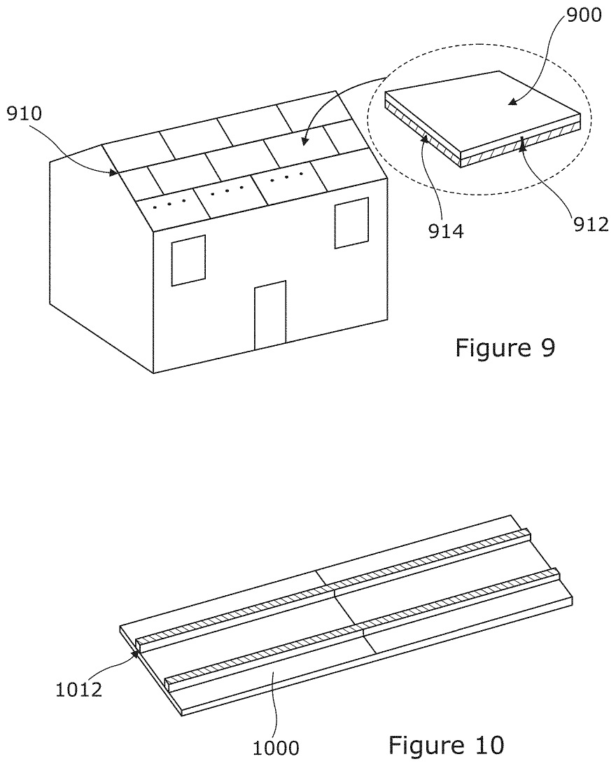

FIG. 9 shows the use of panels or sheets of srPP, or srPP and ePP, fitted to the roof 910 of a building. Each panel or sheet 900 may be a structural sheet or panel as described above. In a specific example, each structural sheet 900 comprises a self-reinforced polyolefin layer of self-reinforced polypropylene and/or of srPET 912. The structural sheet further comprises a layer of polymer foam (here, ePP) 914.

Each roofing panel or sheet may be battened, glued or nailed to the roof base or structure. A traditional roof base or structure can be used, without modification.

In an alternative example, each of the panels described with respect to the roofing panels in FIG. 9 could be provided without use of polymer foam. In other words, the panels may be formed of a self-reinforced polyolefin material only, or in combination with other materials.

FIG. 10 shows the use of structural sheets or panels 1000 (for example, comprising srPP, srPP/ePP, or srPP/ePP/srPP laminated layers), which could be applied to a roof or outer surface of a building for protection. For example, such panels could be applied to the outer surfaces of a building upon receipt of a severe weather warning, to protect the building from flying debris as a result of a hurricane, typhoon etc.

The panels include further battens 1012 of wood and/or of srPP to secure and reinforce the panels 1000. The battens increase the stiffness and structural integrity of the panels. They can also be used as a fastener or connector of the panels to a building.

In an alternative example, each of the structural sheets or panels, or the battens described with respect to FIG. 10 could be provided without use of polymer foam. In other words, the panels or battens may be formed of a self-reinforced polyolefin material only, or in combination with other materials.

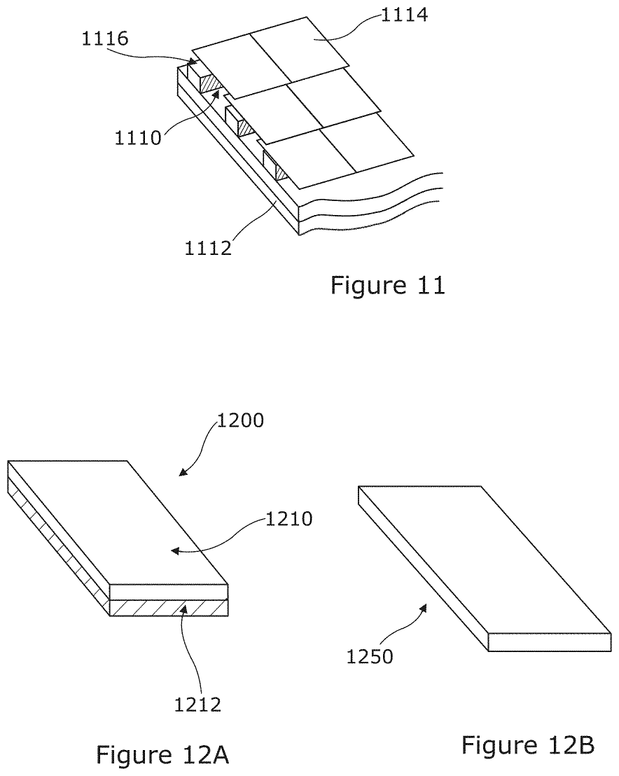

FIG. 11 shows the use of structural panels (comprising srPP or srPP/ePP) as a protection layer 1110 on a roof of a building. The protection layer (and/or battens) 1110 can be those described above with respect to FIG. 6. Alternatively, the protective layer 1110 can be a flexible layer of self-reinforced polyolefin, formed in the manner of a membrane or tarpaulin.

The layers can be applied to a standard or traditional roof base construction 1112, and topped with tiles or roof shingles 1114. Said tiles or roof shingles may also comprise srPP. Alternatively, said tiles or roof shingles can be of a traditional design. The roof tiles or shingles may be pegged to nailed to battens 1116. The battens may be formed of a self-reinforced polyolefin.

FIG. 12A shows a roof tile or shingle 1200 formed as a structural panel as described above. Specifically, the roof tile comprises a layered structure of srPP/srPET 1210 and ePP 1212. FIG. 12B shows an alternative roof tile 1250 formed of a layer of a self-reinforced polyolefin (e.g. srPP) only.

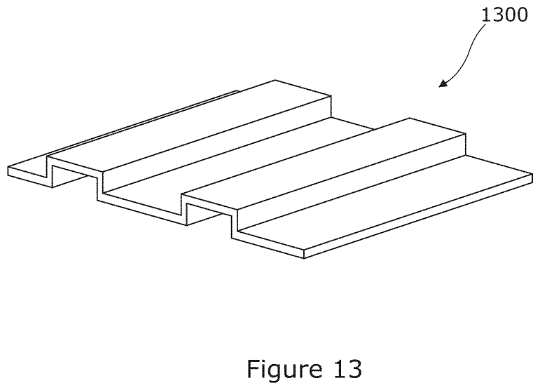

FIG. 13 shows a corrugated sheet 1300, configured from a structural sheet as described above. Specifically, FIG. 13 shows a corrugated roofing sheet comprising srPP, srPET or a combination of these materials. Ideally the corrugated sheets are comprised of multiple layers of these materials, and are shaped or formed in the corrugated structure. The corrugated structure may further strengthen or increase the rigidity of the panel. As an example, the roof tile, fencing panels or shutter panels described above could be formed from the corrugated sheet. In an alternative example, the corrugated sheet in FIG. 13 could be provided without use of polymer foam. In other words, the corrugated sheet may be formed of a self-reinforced polyolefin material only, or in combination with other materials.

As will be appreciated by the skilled person, details of the above embodiment may be varied without departing from the scope of the present invention, as defined by the appended claims.

Many combinations, modifications, or alterations to the features of the above embodiments will be readily apparent to the skilled person and are intended to form part of the invention. Any of the features described specifically relating to one embodiment or example may be used in any other embodiment by making the appropriate changes.

1. A structural sheet, comprising:
a layer of self-reinforced polyolefin;
a layer of polymer foam;
the layer of self-reinforced polyolefin and polymer foam bonded together to form a laminated structure.

2-41. (canceled)
